(19) United States
(12) Patent Application Publication
(10) Pub. No.: US 2026/0322013 A1
(43) Pub. Date: Oct. 15, 2026

(54) CONNECTOR

(71) Applicant: Molex, LLC, Lisle, IL (US)

(72) Inventors: Masahiro Takahashi, Yamato (JP); Junichi Asanuma, Yamato (JP)

(21) Appl. No.: 19/461,745

(22) Filed: Jan. 28, 2026

(30) Foreign Application Priority Data
Jan. 28, 2025 (JP) 2025-012086

(51) Int. Cl. H01R 12/79; H01R 13/627; H01R 13/633

(52) U.S. Cl. CPC H01R 12/79; H01R 13/6271; H01R 13/633

(57) ABSTRACT

An embodiment includes a housing including an insertion opening into which a flat cable is inserted and a stowing space for stowing the inserted flat cable, where a terminal is attached to the housing and a button is attached to the housing; and a metal fitting is attached to the housing, wherein the metal fitting includes a support part that is supported by the housing and an engaging part that engages with an engaged part of the flat cable, and the support part and the engaging part are connected by a connecting part and the connecting part includes a roughly U-shaped curved part formed from the button side toward the insertion opening and extending in the same direction as the plane of the board on which the connector is mounted.

### TECHNICAL FIELD

The present disclosure relates to a connector.

### BACKGROUND ART

Conventionally, connectors for flat cables such as FPC (Flexible Printed Circuit) connectors and FFC (Flexible Flat Cable) connectors have been used to connect flat cables such as flexible circuit board and flexible flat cables (see, for example, Patent Document 1).

FIG. 19 is a perspective view depicting a conventional connector.

In the figure, 811 is a housing of a connector mounted on a board 891 such as a printed circuit board, and is a hollow member having an outer shape like a flat box made of an insulating material such as synthetic resin, and a flat cable 901 tip end portion is inserted into the internal space of the housing 811 through an insertion opening formed on the front surface and connected to the connector. In addition, metal securing members 851 are provided on both the left and right sides of the housing 811 to secure the inserted flat cable 901 to the connector.

Each securing member 851 has a cantilever-shaped leaf spring part 852 that extends from a base end portion secured to the housing 811 toward the center of the housing 811 in the width direction. Furthermore, at the tip ends of the left and right leaf spring parts 852, plate-shaped protruding pieces (not depicted) that protrude downward are formed, and these plate-shaped protrusions enter and engage into recessed parts (not depicted) formed on both left and right side edges near the tip end of the flat cable 901. As a result, the flat cable 901, having a tip end portion inserted into the internal space of the housing 811, will not separate from the housing 811 even if an external withdrawal force is applied in the direction opposite to the insertion direction, thereby preventing disconnection from the connector.

In addition, a plurality of terminals 861 are attached to the housing 811. Each terminal 861 is a long, thin, strip-shaped member made of a bent thin metal plate, and is inserted forward from the rear end of the housing 811, with the base end (not depicted) thereof secured to the rear end of the housing 811 and the tip end (not depicted) thereof in contact with the conductive wire exposed at the tip end portion (not depicted) of the flat cable 901. As a result, each conductive wire of the flat cable 901 is electrically connected to the corresponding terminal 861.

Furthermore, slide members 857 that are slidable in the front-to-back direction are attached to the left and right outer sides of the terminal 861 at the rear end of the housing 811. When releasing connection of the flat cable 901 and removing from the connector, the operator operates the left and right slide members 857 with fingers or the like to move the members forward. Then, the tip end portion of each slide member 857 abuts against the inclined surface (not depicted) of a contacting part 852a formed on the leaf spring part 852 of each securing member 851, thereby lifting the tip end of the leaf spring part 852, and thereby disengaging the plate-shaped protruding pieces formed on the tip end of the leaf spring part 852 from the recessed part of the flat cable 901. When the engagement between the leaf spring part 852 and the plate-shaped protruding piece is released in this manner, the flat cable 901 can be pulled out and removed from the housing 811 by applying a withdrawal force to the flat cable 901.

### SUMMARY

However, with the conventional connector, the operation of connecting and disconnecting the flat cable 901 cannot be performed smoothly, and performing the operation of connecting and disconnecting many times repeatedly is difficult.

In addition, in recent years, electronic devices such as laptop computers, tablets, smartphones, smartwatches, digital cameras, music players, game consoles, and navigation devices have come to require smaller and lower-profile cases and therefore smaller and lower-profile components, which has resulted in a demand for smaller and lower-profile connector assemblies as well.

However, in the conventional connector, the securing members 851 are attached to both the left and right sides of the housing 811, and the sliding members 857 are attached to the outside left and right sides of the terminals 861, which results in an increase in the size of the connector. In addition, when disconnecting the flat cable 901, the operator must operate the separate left and right slide members 857 while pulling out the flat cable 901, making performing the disconnection operation difficult. Therefore, if the operation of connecting and disconnecting the flat cable 901 is repeated many times, the workability is significantly reduced.

An object is to solve the above-mentioned conventional problems and to provide a connector that is simple in configuration, easy to manufacture, can be made small and low-profile, is easy to connect and disconnect, and is highly reliable.

Therefore, a connector includes:
a housing including an insertion opening into which a flat cable is inserted and
a stowing space for stowing the inserted flat cable;
a terminal attached to the housing;
a button attached to the housing; and
a metal fitting attached to the housing, wherein
the metal fitting includes a support part supported by the housing and an engaging part that engages with an engaged part of the flat cable, and
the support part and the engaging part are connected by a connecting part, the connecting part including a roughly U-shaped curved part formed from the button side toward the insertion opening, and extending in the same direction as the plane of the board on which the connector is mounted.

In another connector, the U-shaped part of the curved part is formed wider than the other portion of the curved part.

In still another connector, the engaging part includes a tab part extending downward, at least a part of the tab part being positioned within the through hole of the housing, and a lower end of the tab part protruding into the stowing space.

In still another connector, the button is arranged on the opposite side of the housing from the insertion opening.

In still another connector, the support part includes a board connection part, and the engaging part includes a tab, a first part of which is connected to the connecting part and a second part of which is capable of contacting the button.

In yet another connector, the metal fittings are arranged on both sides of the housing in the width direction, and when the button swings, the tab is pushed up, releasing the engagement between the engaging part and the engaged part of the flat cable.

According to the present disclosure, the connector has a simple configuration, is easy to manufacture, can be made small and low-profile, is easy to connect and disconnect, and can have improved reliability.

### BRIEF DESCRIPTION OF THE DRAWINGS

FIGS. 1A and 1B are a first set of perspective views depicting a state in which a flat cable is connected to a connector according to the present embodiment, where FIG. 1A is a perspective view as viewed diagonally from above the front, and FIG. 1B is a first perspective view as viewed diagonally from below the front;

FIGS. 2A and 2B are a second set of perspective views depicting the state in which a flat cable is connected to a connector according to the present embodiment, where FIG. 2A is a perspective view as viewed from behind, and FIG. 2B is a second perspective view as viewed diagonally from below the front;

FIGS. 3A and 3B are a first set of perspective views of the connector according to the present embodiment, in which FIG. 3A is a perspective view as viewed diagonally from above the front, and FIG. 3B is a first perspective view as viewed diagonally from below the front;

FIGS. 4A and 4B are a second set of perspective views depicting the connector according to the present embodiment, in which FIG. 4A is a perspective view as viewed from behind, and FIG. 4B is a second perspective view as viewed diagonally from below the front;

FIG. 5 is an exploded perspective view of the connector according to the present embodiment;

FIGS. 6A-6D are a four-plane diagram of the connector according to the present embodiment, where FIG. 6A is a top view, FIG. 6B is a front view, FIG. 6C is a bottom view, and FIG. 6D is a left-side view;

FIGS. 7A and 7B are a two-plane diagram of the connector according to the present embodiment, where FIG. 7A is a right-side view and FIG. 7B is a rear view;

FIGS. 8A-8F are a six-plane diagram of the metal fittings of the connector according to the present embodiment, where FIG. 8A is a top view, FIG. 8B is a right-side view, FIG. 8C is a front view, FIG. 8D is a left-side view, FIG. 8E is a rear view, and FIG. 8F is a bottom view;

FIG. 9 is a perspective view depicting a state in which a button on the connector according to the present embodiment is operated;

FIGS. 10A and 10B are a two-plane diagram depicting a state in which the button on the connector according to the present embodiment is operated, where FIG. 10A is a front view and FIG. 10B is a cross-sectional view along line A-A in FIG. 10A;

FIG. 11 is a front view depicting a state in which a flat cable is connected to the connector according to the present embodiment;

FIGS. 12A and 12B are a first set of side cross sectional views depicting a state in which a flat cable is connected to a connector according to the present embodiment, where FIG. 12A is a cross-sectional view along line B-B in FIG. 11, and FIG. 12B is a cross-sectional view along line C-C in FIG. 11;

FIGS. 13A and 13B are a second set of side cross sectional views depicting the state in which the flat cable is connected to the connector according to the present embodiment, where FIG. 13A is a cross-sectional view along line D-D in FIG. 11, and FIG. 13B is a cross-sectional view along line E-E in FIG. 11;

FIG. 14 is a perspective view depicting a state in which the button is operated when the flat cable is removed from the connector according to the present embodiment;

FIG. 15 is a front view depicting a state in which the button is operated when the flat cable is removed from the connector according to the present embodiment;

FIGS. 16A and 16B are a side cross sectional view depicting the state in which the button is operated when removing the flat cable from the connector according to the present embodiment, where FIG. 16A is a cross-sectional view along the line F-F in FIG. 15, and FIG. 16B is a cross-sectional view along line G-G in FIG. 15;

FIG. 17 is another front view depicting the state in which the flat cable is connected to the connector according to the present embodiment;

FIG. 18 is a side cross-sectional view depicting a state in which the flat cable is connected to the connector according to the present embodiment, and is a cross-sectional view along the line H-H in FIG. 17;

FIG. 19 is a perspective view depicting a conventional connector.

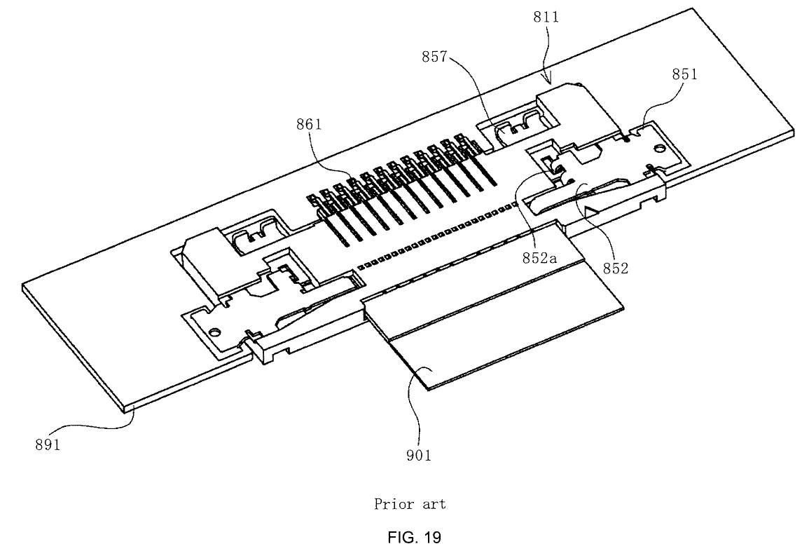

### DETAILED DESCRIPTION OF THE PREFERRED EMBODIMENTS

Embodiments will hereinafter be described in detail with reference to the drawings.

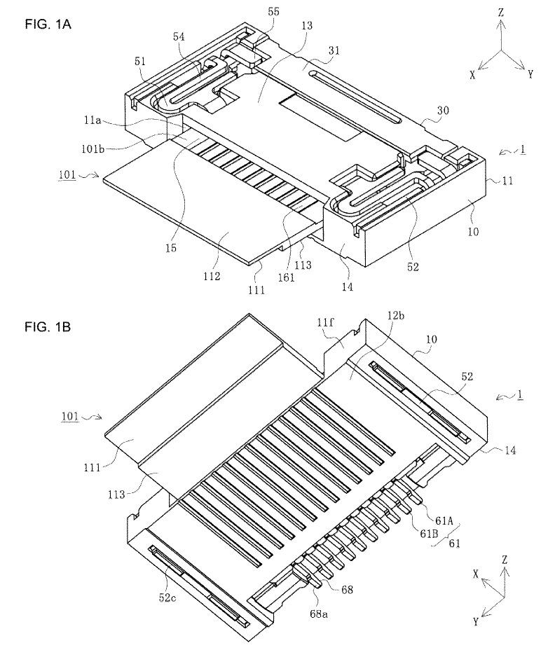

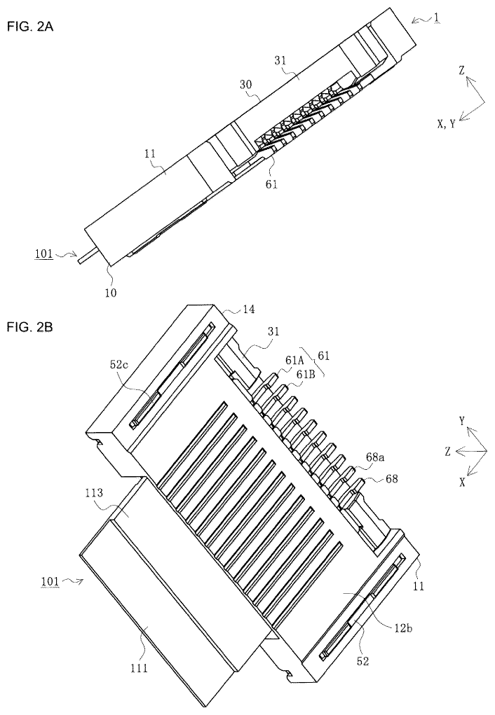

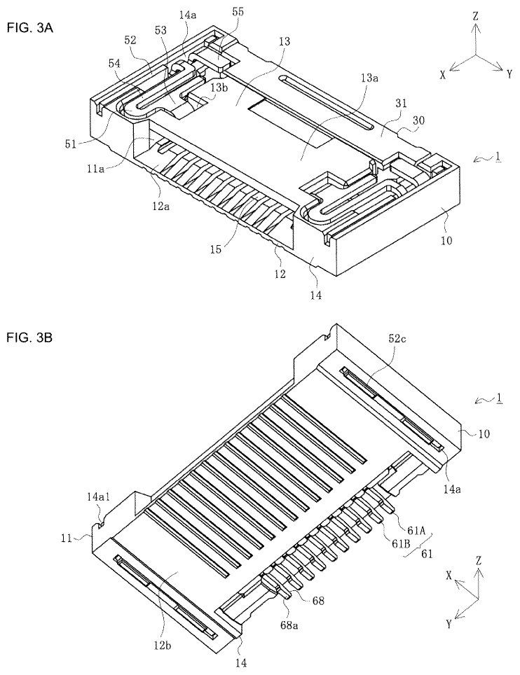

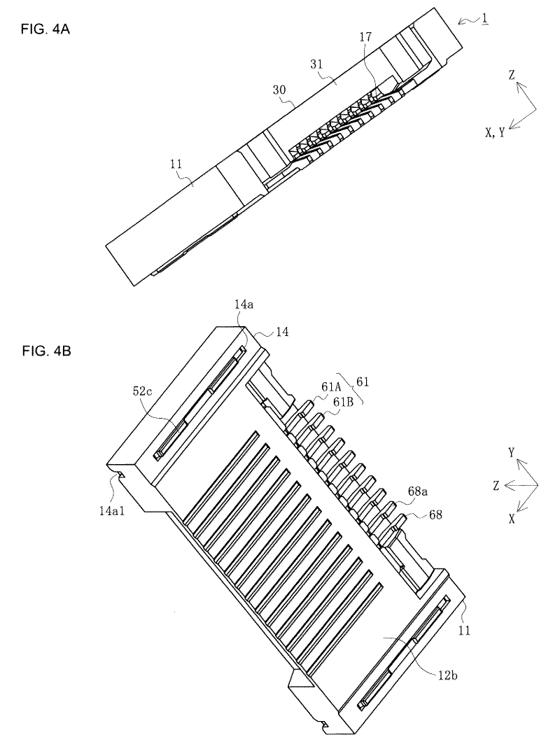

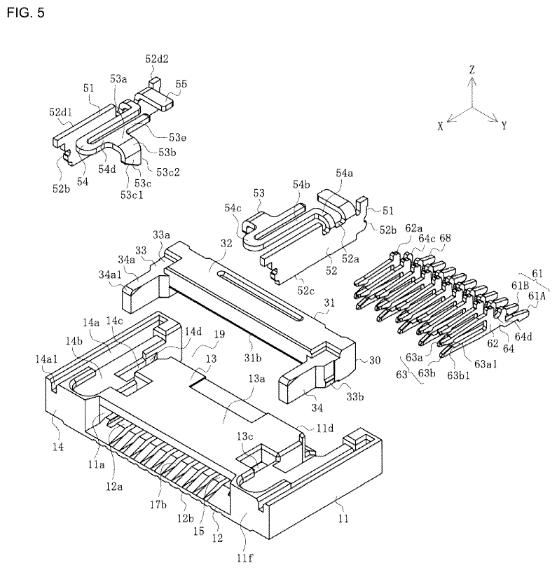

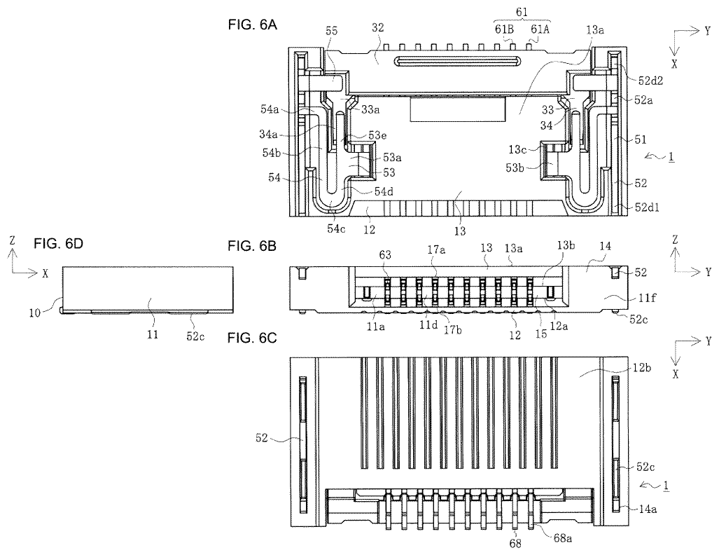

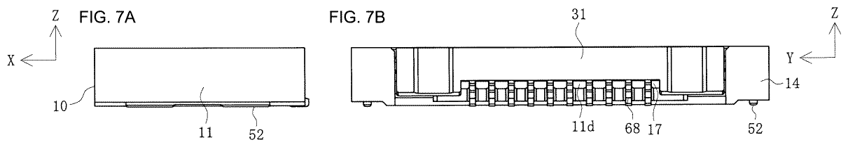

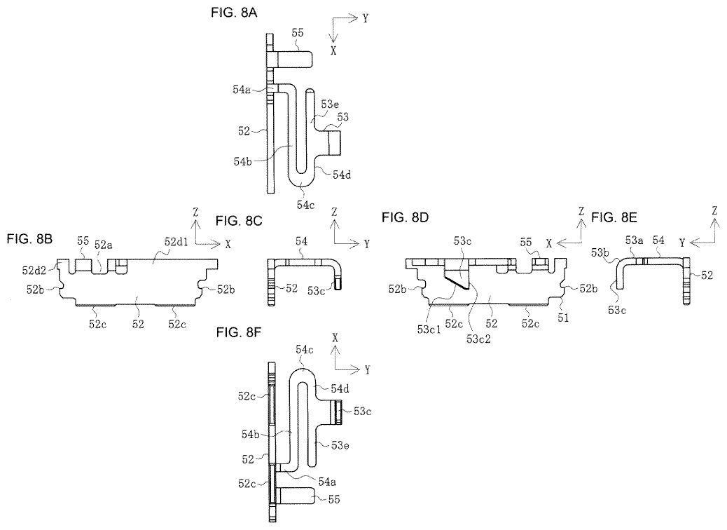

FIGS. 1A and 1B are a first set of perspective views depicting a state in which a flat cable is connected to a connector according to the present embodiment. FIGS. 2A and 2B are a second set of perspective views depicting a state in which a flat cable is connected to a connector according to the present embodiment. FIGS. 3A and 3B are a first set of perspective views of the connector according to the present embodiment. FIGS. 4A and 4B are a second set of perspective views depicting the connector according to the present embodiment. FIG. 5 is an exploded perspective view of the connector according to the present embodiment. FIGS. 6A-6D are a four-plane diagram of the connector according to the present embodiment. FIGS. 7A and 7B are a two-plane diagram of the connector according to the present embodiment. FIGS. 8A-8F are a six-plane diagram of the metal fittings of the connector according to the present embodiment. Note that in FIGS. 1A and 1B, FIG. 1A is a perspective view as viewed diagonally from above the front, and FIG. 1B is a first perspective view as viewed diagonally from below the front. In FIGS. 2A and 2B, FIG. 2A is a perspective view as viewed from behind, and FIG. 2B is a second perspective view as viewed diagonally from below the front. In FIGS. 3A and 3B, FIG. 3A is a perspective view as viewed diagonally from above the front, and FIG. 3B is a first perspective view as viewed diagonally from below the front. In FIGS. 4A and 4B, FIG. 4A is a perspective view as viewed from behind, and FIG. 4B is a second perspective view as viewed diagonally from below the front. In FIGS. 6A-6D, FIG. 6A is a top view, FIG. 6B is a front view, FIG. 6C is a bottom view, and FIG. 6D is a right side view. In FIGS. 7A and 7B, FIG. 7A is a left side view and FIG. 7B is a rear view. In FIGS. 8A-8F, FIG. 8A is a top view, FIG. 8B is a right side view, FIG. 8C is a front view, FIG. 8D is a left side view, FIG. 8E is a rear view, and FIG. 8F is a bottom view.

In the figures, reference numeral 1 denotes a connector according to the present embodiment, which is mounted on the surface of a board such as a circuit board (not depicted) and is used to electrically connect a flat cable 101. In addition, the connector 1 is used as a so-called right-angle type connector, and is mounted sideways relative to the board, in other words, with the lower surface of the housing main body 11 of the housing 10 (the lower surface 12b of the lower plate part 12 of the housing main body 11) facing the surface (flat surface) of the board and is a small, low-profile connector with, for example, a length (dimension in the X-axis direction) of approximately 5.4 mm, a width (dimension in the Y-axis direction) of approximately 10.7 mm, and a height (dimension in the Z-axis direction) of approximately 1.5 mm.

In addition, the flat cable 101 is a flat flexible cable called, for example, FPC, FFC, or the like but any type of flat cable including conductive wire 161 may be used. Furthermore, the flat cable 101 is moved relative to the connector 1 in a first direction, that is, an insertion direction (X-axis negative direction), and is inserted into the insertion opening 11a formed on the front surface 11f of the housing main body 11, and is connected to the connector 1 as depicted in FIGS. 1A and 1B and 2A and 2B.

Note that in the present embodiment, the expressions indicating directions such as up, down, left, right, front, and rear used to describe the configuration and operation of each part of the connector 1 and flat cable 101 are not absolute but relative, and are appropriate when each part of the connector 1 and flat cable 101 is in the orientation depicted in the figure, but if the orientation changes, they should be interpreted differently in accordance with the change in orientation.

As depicted in the figure, the connector 1 includes a housing 10 and a button 30 attached to the housing 10. The button 30 is arranged on the opposite side of the housing 10 from the insertion opening 11a. The housing 10 includes a housing main body 11 as a main body part, and the button 30 includes a button main body 31 as a main body part. The housing main body 11 and the button main body 31 are each an integrally formed member made of an insulating material such as synthetic resin. In addition, the connector 1 also includes a metal fitting 51 which is a reinforcing member made of metal, and a terminal 61 which is a conductive member made of metal.

The housing main body 11 includes a lower plate part 12 having a generally flat shape extending in the length direction (X-axis direction) and width direction (Y-axis direction) of the housing 10, an upper plate part 13 having a generally flat shape extending parallel to the lower plate part 12 in the length direction and width direction of the housing 10 above the lower plate part 12, a pair of left and right side wall parts 14 having a generally rectangular column shape connected to the left and right side edges of the lower plate part 12 and the upper plate part 13 and extending in the length direction of the housing 10, and a rear wall part 11d connecting the rear end edges of the lower plate part 12 and the upper plate part 13. The upper surface 13a of the upper plate part 13 is a substantially flat surface, and also serves as the upper surface of the housing main body 11. In addition, the space defined by the lower plate part 12, the upper plate part 13, the side wall parts 14 on both sides, and the rear wall part 11d is a cable stowing space 15 where the connection portion 101b near the tip end of the flat cable 101 is stowed. The cable stowing space 15 is a space that is open to the front (X-axis positive direction), and the front end thereof is an insertion opening 11a formed on the front surface 11f of the housing main body 11. Note that the rear wall part 11d functions as a terminal retaining part, and is formed with a plurality of slit-shaped openings of terminal retaining recessed parts 17 that penetrate the rear wall part 11d in the front-to-back direction (X-axis direction).

Furthermore, as depicted in the figure, a plurality of terminals 61 are attached and retained on the rear wall part 11d. There are a plurality of terminals 61 (10 in the example depicted in the figure), and they are arranged in a row in the width direction of the housing main body 11 at a prescribed pitch (for example, about 0.5 mm). In addition, each terminal 61 is a member that is integrally formed by subjecting a conductive metal plate to processing such as punching. Note that each terminal 61 may be integrally attached to the housing main body 11 by a molding method referred to as overmolding, outsert molding, or insert molding (hereinafter referred to as “insert molding”); however, in the present embodiment, each terminal 61 is press-fitted and secured from the rear into a corresponding terminal retaining recessed part 17 of the rear wall part 11d.

In addition, the terminals 61 include a terminal 61A which is a first type terminal and a terminal 61B which is a second type terminal. As depicted in FIG. 5, when the terminals are arranged in a line in the width direction of the housing main body 11, the terminals 61A and terminals 61B are arranged alternately. In the example depicted in the figure, the tip end of terminal 61A is arranged so as to be positioned forward (X-axis positive direction) of the tip end of terminal 61B. Note that when the terminal 61A and terminal 61B are described collectively, they will be referred to as the terminal 61.

Each terminal 61 extends roughly in the vertical direction and includes a base part 62 as a support part supported by the terminal retaining recessed part 17 of the housing main body 11, and an upper arm part 63a and a lower arm part 63b connected near the upper end (Z-axis positive direction end) and near the lower end (Z-axis negative direction end) of the front end (X-axis positive direction end) of the base part 62. A plurality of slit-shaped upper arm stowing grooves 17a extending forward (X-axis positive direction) from each terminal retaining recessed part 17 are formed on a lower surface 13b of the upper plate part 13 of the housing main body 11, and a plurality of slit-shaped lower arm stowing grooves 17b extending forward from each terminal retaining recessed part 17 are formed on an upper surface 12a of the lower plate part 12 of the housing main body 11. At least a part of each upper arm part 63a is stowed in the corresponding upper arm stowing groove 17a, and at least a part of each lower arm part 63b is stowed in the corresponding lower arm stowing groove 17b. The number and pitch of the upper arm stowing grooves 17a and the lower arm stowing grooves 17b are the same as the number and pitch of the terminals 61.

Note that when the upper arm part 63a and the lower arm part 63b are described collectively, they will be described as an arm part 63. The arm part 63 of the terminal 61A is set to be longer than the arm part 63 of the terminal 61B. Note that the upper arm part 63a and the lower arm part 63b of the terminal 61A have approximately the same length, and the upper arm part 63a and the lower arm part 63b of the terminal 61B also have approximately the same length.

In addition, at the free end, in other words, the tip end, of the upper arm part 63a, an upper contact part 63a1 is formed as a contact protruding part that contacts the upper surface of the flat cable 101 and protrudes downward from the upper arm stowing groove 17a, and at the free end, in other words, the tip end, of the lower arm part 63b, a lower contact part 63b1 is formed as a contact protruding part that contacts the lower surface of the flat cable 101 and protrudes upward from the lower arm stowing groove 17b. Furthermore, the upper arm part 63a and the lower arm part 63b are members that function as cantilever-like spring members that extend forward from the base part 62 and are elastically displaceable in the vertical direction. The upper contact part 63a1 and the lower contact part 63b1 are preferably formed to have a shape similar to a triangle, in which the front edge extends linearly with an inclination such that the front edge descends and ascends as the front edge proceeds rearward. The upper contact part 63a1 and the lower contact part 63b1 are pressed against the upper surface and lower surface of the flat cable 101 by the spring forces exerted by the upper arm part 63a and the lower arm part 63b.

The base part 62 is a rectangular member extending in the vertical direction, and an engaging protruding part 62a is formed at the upper end thereof. When the base part 62 is pressed into the slit-shaped terminal retaining recessed part 17 extending in the vertical direction and formed in the rear wall part 11d, the lower end thereof abuts the lower wall surface of the terminal retaining recessed part 17, and the engaging protruding part 62a bites into and engages with the upper wall surface of the terminal retaining recessed part 17, so that the base part 62 is stably retained in the rear wall part 11d.

In addition, the front end of a rear part 64 serving as a button rotation support part is connected to the lower portion of the rear end of the base part 62. A recessed part 64d that functions as a rotation support part for the button 30 is formed at the upper edge of the rear part 64 at a location adjacent to the rear edge of the base part 62. In addition, at the rear end of the recessed part 64d on the upper edge of the rear part 64, a recessed rear wall part 64c is formed that protrudes upward. The lower surface of the button main body 31 has a downwardly protruding rotary shaft part 31b formed along the front end edge, and a lower surface recessed part 31c (described later) formed behind the rotary shaft part. The rotary shaft part 31b is stowed in a recessed part 64d, and a recessed rear wall part 64c is formed in the lower surface recessed part 31c. Note that the recessed part 64d in the terminal 61B is formed to be deeper than the recessed part 64d in the terminal 61A. That is, the bottom of the recessed part 64d in the terminal 61B is positioned lower than the bottom of the recessed part 64d in the terminal 61A. By doing so, the frictional force between the terminal 61 and the button 30 can be adjusted, but the bottom of the recessed part 64d in the terminal 61B and the bottom of the recessed part 64d in the terminal 61A may be at the same position.

Furthermore, the terminal 61 includes a tail part 68 as a board connection part that is formed behind the rear part 64 and extends toward the rear end (X-axis negative direction end). The tail part 68 has a front end thereof connected to the rear end of the rear part 64 at the lower end edge thereof. Therefore, the connection location between the rear part 64 and the tail part 68 has a generally crank-like shape when viewed from the side (Y-axis direction). In addition, the rear end of the tail part 68 is displaced downward relative to the entire tail part 68, and the lower end surface 68a thereof functions as a board connection surface that can be connected by soldering or the like to a connection pad or the like (not depicted) formed on the surface of the board.

When the terminals 61 are attached to the housing main body 11, the arm parts 63 of the plurality of terminals 61 protrude forward from the rear wall part 11d and are arranged in the cable stowing space 15 in a comb-like pattern. Note that at least a part of each upper arm part 63a is stowed in the corresponding upper arm stowing groove 17a, and at least a part of each lower arm part 63b is stowed in the corresponding lower arm stowing groove 17b. Furthermore, the upper contact part 63a1 and the lower contact part 63b1 of the terminal 61A and the upper contact part 63a1 and the lower contact part 63b1 of terminal 61B are arranged alternately so that the upper contact part 63a1 and the lower contact part 63b1 of terminal 61A are positioned forward of the upper contact part 63a1 and the lower contact part 63b1 of terminal 61B. Therefore, the upper contact parts 63a1 and the lower contact parts 63b1 of each terminal 61 are arranged in a staggered pattern in plan view. Note that the position of the rear end of the tail part 68 in the length direction of the housing main body 11 is the same for both the terminal 61A and the terminal 61B.

In addition, metal fitting retaining grooves 14a are formed in side wall parts 14 on both sides of the housing main body 11 near the outer ends in the width direction of the housing 10, and extend vertically through the side wall parts 14. Note that the metal fitting retaining groove 14a is a long, narrow slit-like groove extending in the front-to-back direction in plan view, and only an upper end proximal part 14a1 opens to the front surface 11f of the housing main body 11. Furthermore, a metal fitting stowing recessed part 14b is formed on the upper surface of the side wall part 14 at a location adjacent to the metal fitting retaining groove 14a and closer to the inner side of the housing 10 in the width direction, and indented downward. Furthermore, a button stowing groove 14c is formed between the inner end of the side wall part 14 in the width direction of the housing 10 and the outer end of the upper plate part 13 in the width direction of the housing 10. Note that a retaining engagement protruding part 14d is preferably formed on the outer wall surface of the button stowing groove 14c in the width direction of the housing 10. Furthermore, an engaging tab stowing opening 13c is formed on the upper plate part 13 as a through hole that penetrates the upper plate part 13 in the vertical direction at a location adjacent to the metal fitting stowing recessed part 14b near the outer widthwise end of the housing 10.

In addition, the space defined by the rear wall part 11d and the side wall parts 14 on both sides is a button stowing space 19 in which the button main body 31 is stowed. When the button 30 is not attached to the housing 10, the button stowing space 19 is a space that is open in the vertical and rearward directions (X-axis negative direction).

In the present embodiment, for the sake of convenience, the flat cable 101 includes a connection portion 101b, which is a portion within a prescribed length from the tip end and which is connected to the connector 1, and on both side edges of the connection portion 101b, as described below, recessed parts 115 are formed as engaged parts that are indented inward in the width direction, and the front part of the recessed parts 115 protrudes relatively more outward in the width direction than the recessed parts 115 to form ear parts 115a. The flat cable 101 has a board part 111, which is an insulating thin plate member having a long, thin strip shape, and a plurality of conductive wires 161 arranged on one surface of the board part 111 (the upper surface in the example depicted in FIG. 1A) and extending in the length direction of the flat cable 101. Note that in the figure, only the portion of the flat cable 101 near the connection portion 101b is depicted, and other portions are omitted from the figure.

The conductive wires 161 are, for example, foil-like linear bodies made of a conductive metal such as copper, and a plurality of pieces (10 pieces in the example depicted in FIG. 1A) are arranged side by side in the width direction of the flat cable 101 at a prescribed pitch, for example, about 0.5 mm. Note that the number and pitch of the conductive wires 161 can be changed as needed. Furthermore, the surface of the conductive wire 161 (the upper surface in the example depicted in FIG. 1A) is covered with an insulating layer 112. Note that at the connection portion 101b of the flat cable 101, the insulating layer 112 is removed, and the surface of the conductive wire 161 is exposed. In addition, a reinforcement plate 113 is attached to the surface of the board part 111 opposite to the side where the conductive wires 161 are exposed (the lower surface in the example depicted in FIG. 1A).

The metal fittings 51 are a pair of left and right members, each of which is an integrally formed member including a roughly flat support part 52 extending in the lengthwise direction (X-axis direction) and vertical direction (Z-axis direction) of the housing 10, a connecting part 54 connected to the upper edge of the support part 52, an engaging part 53 connected to the connecting part 54, and a button restraining part 55 connected to the upper edge of the support part 52. The connecting part 54 is a long, thin, strip-shaped plate member that extends almost entirely on a plane parallel to the upper plate part 13 of the housing main body 11, in other words, extends in the same direction as the surface (plane) of the board on which the connector 1 is mounted, and has a shape that is roughly curved like a hairpin when viewed in a plane. The shapes of the left and right metal fittings 51 are mirror symmetrical or mirror image symmetrical to each other.

Note that the upper edge of the support part 52 includes a front part 52d1 positioned at the front end thereof, a rear part 52d2 positioned at the rear end thereof, and a recessed part 52a between the front part 52d1 and the rear part 52d2 that is indented below the front part 52d1 and the rear part 52d2, and the connecting part 54 and the button restraining part 55 are connected to the recessed part 52a. In addition, the front end edge and rear end edge of the support part 52 are formed with concave and convex support engaging parts 52b. Furthermore, a lower end surface 52c of the support part 52 functions as a board connection part that can be connected to a connection pad or the like (not depicted) formed on the surface of the board.

The connecting part 54 includes a support part connecting part 54a that extends upward from the recessed part 52a at the upper edge of the support part 52, then bends approximately 90 degrees and extends toward the center of the inside of the housing 10 in the width direction (Y-axis direction); a first straight part 54b that is connected to the inside end of the support part connecting part 54a in the width direction of the housing 10 and extends linearly toward the front of the housing 10 in the length direction on a plane parallel to the upper plate part 13; a U-shaped part 54c that has a first end connected to the tip end of the first straight part 54b, bends approximately 180 degrees on a plane parallel to the upper plate part 13, and then makes a U-turn toward the rear of the housing 10 in the length direction; and a second straight part 54d that is connected to a second end of the U-shaped part 54c and extends linearly toward the rear of the housing 10 in the length direction on a plane parallel to the upper plate part 13. Note that the first straight part 54b, the second straight part 54d, and the U-shaped part 54c can be integrated together to form a roughly U-shaped curved part formed from the button 30 side toward the insertion opening 11a.

The curved part is a long, thin, strip-shaped plate member that proceeds linearly from rear to front, then makes a U-turn and extends along a path that proceeds linearly toward rear, but the widthwise dimension thereof, which is the direction orthogonal to the path in plan view, is not constant. In other words, the widthwise dimensions of the first straight part 54b and the second straight part 54d are the same and constant, but the widthwise dimension of the U-shaped part 54c is larger than that of the first straight part 54b and the second straight part 54d. That is, the U-shaped part 54c is composed of a plate member that is wider than the first straight part 54b and the second straight part 54d. Note that the thickness (dimension in the Z-axis direction) of the plate member is the same and constant in the U-shaped part 54c, the first straight part 54b, and the second straight part 54d.

In addition, the engaging part 53 includes a connection connecting part 53a extending from near the rear end of the second straight part 54d toward the inside of the housing 10 in the width direction, a curved part 53b bending approximately 90 degrees from the inside end of the connection connecting part 53a in the width direction of the housing 10 and extending downward, and a tab part 53c extending downward from the lower end of the curved part 53b. When viewed from the side (Y-axis direction), the tab part 53c preferably has a shape resembling a right-angled triangle, with a rear edge 53c2 thereof extending in the vertical direction (Z-axis direction) and the front edge 53c1 thereof extending in a straight line that is inclined upward proceeding forward. The engaging part 53 further includes a pushed-up part 53e as a tab with a first end connected to the rear end of the second straight part 54d and which extends linearly rearward in the length direction of the housing 10 on a plane parallel to the upper plate part 13.

Furthermore, the button restraining part 55 is a strip-shaped plate member that extends upward from the recessed part 52a at the upper edge of the support part 52, then curves approximately 90 degrees and extends toward the center of the inside of the housing 10 in the width direction (Y-axis direction). Note that the button restraining part 55 is positioned rearward of the pushed-up part 53e.

In the initial state of the metal fitting 51, in other words, when no external force is applied, the front part 52d1 and rear part 52d2 at the upper edge of the support part 52, the first straight part 54b, U-shaped part 54c and second straight part 54d at the connecting part 54, the connection connecting part 53a and pushed-up part 53e at the engaging part 53, and the upper surface of the button restraining part 55 can be said to be essentially on the same plane extending in the length direction (X-axis direction) and width direction (Y-axis direction) of the housing 10.

The button main body 31 includes an approximately flat operating plate part 32 extending in the length direction (X-axis direction) and width direction (Y-axis direction) of the housing 10, a thicker root part 33 formed on both the left and right edges of the operating plate part 32 as the root part of the operating arm, and an operating arm part 34 formed to protrude forward from the front end of each root part 33. Note that the upper surface 33a of the root part 33 and the upper surface 34a of the operating arm part 34 are formed flat so as to constitute the same plane. In addition, the dimension of the operating arm part 34 in the width direction of the housing 10 is set to be smaller than the dimension of the root part 33. That is, in plan view, the operating arm part 34 is narrower than the root part 33. Furthermore, a retained engagement protruding part 33b is preferably formed on the outer surface of the root part 33 in the width direction of the housing 10, which is capable of engaging with the retaining engagement protruding part 14d of the button stowing groove 14c. Note that as mentioned above, the lower surface of the button main body 31 is formed with a rotary shaft part 31b that protrudes downward along the front end edge, and a lower surface recessed part 31c, which will be described later, formed behind the rotary shaft part.

Furthermore, the button main body 31 is lowered from above into the housing 10 with all the terminals 61 attached to the housing main body 11, and is stowed in the button stowing space 19. Thereafter, the left and right root parts 33 and the operating arm part 34 are stowed in the corresponding button stowing grooves 14c of the housing main body 11, the rotary shaft part 31b is stowed in the recessed part 64d of each terminal 61, and the recessed rear wall parts 64c of each terminal 61 are stowed in the lower surface recessed parts 31c. Thereby the button main body 31 is prevented from moving further downward relative to the housing 10 and also prevents the button main body from moving in the front-to-back direction relative to the housing 10.

Note that when the button main body 31 is in a stowed state in the button stowing space 19, the upper surface of the operating plate part 32 forms approximately the same plane as the upper surface 13a of the upper plate part 13 of the housing main body 11.

Next, the left and right metal fittings 51 are lowered from above onto the housing 10 and attached to the housing main body 11. Specifically, the support part 52 is pressed into the metal fitting retaining groove 14a from above, and the support engaging parts 52b formed on the front end edge and rear end edge of the support part 52 bite into and engage with the front end wall and rear end wall of the metal fitting retaining groove 14a. Thereby, each metal fitting 51 can be securely retained in the housing main body 11. The connecting part 54 is stowed in the metal fitting stowing recessed part 14b, and at least a part of the tab part 53c of the engaging part 53 is positioned and stowed in the engaging tab stowing opening 13c. Note that at least the lower end of the tab part 53c protrudes into the cable stowing space 15 below the engaging tab stowing opening 13c. The lower limit position of the lower end of the tab part 53c is preferably controllable in an appropriate manner. In addition, the pushed-up part 53e of the engaging part 53 protrudes above the button stowing groove 14c and is positioned above the upper surface 34a of the operating arm part 34 of the button 30 stowed in the button stowing groove 14c. Furthermore, at least the portion near the tip end of the button restraining part 55 protrudes above the button stowing space 19, which is located widthwise inside the housing 10 more inward than the side wall part 14, and is positioned above the upper surface 33a of the root part 33 of the button 30 stowed in the button stowing space 19. Thereby, the button main body 31 is prevented from moving upward relative to the housing 10 beyond the button restraining part 55, which prevents the button main body 31 from slipping out upward from the button stowing space 19.

Thereby, the connector 1 depicted in FIGS. 3A and 3B, 4A and 4B, 6A-6D, and 7A and 7B can be obtained. The lower end surfaces 68a of the tail parts 68 of each terminal 61 and the lower end surfaces 52c of the support parts 52 of the left and right metal fittings 51 are exposed on the lower surface of the connector 1.

Next, operation of the button 30 in the connector 1 having the above configuration will be described.

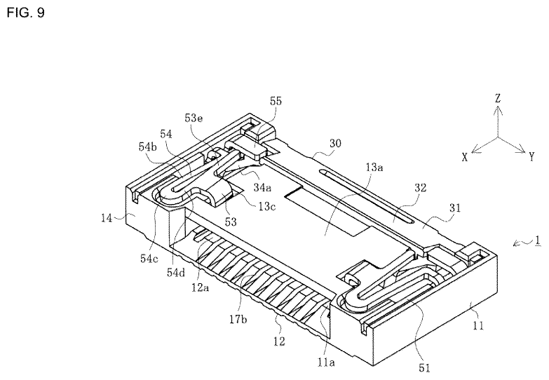

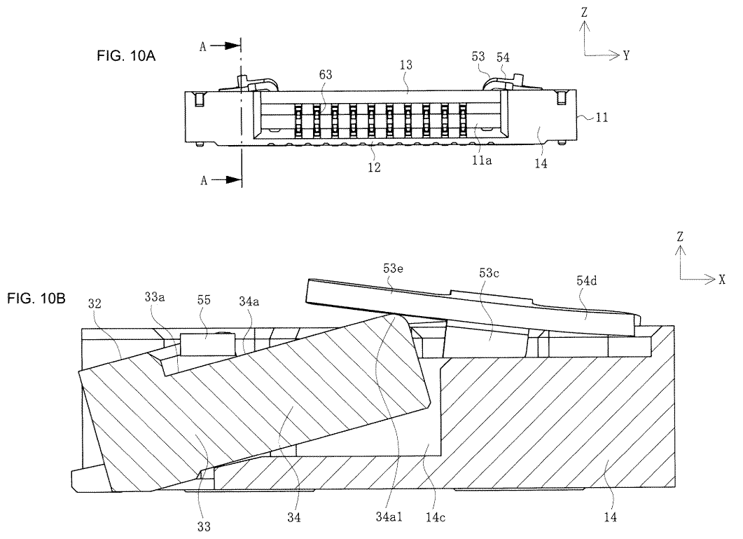

FIG. 9 is a perspective view depicting a state in which the button on the connector according to the present embodiment is operated. FIGS. 10A and 10B are a two-plane diagram depicting a state in which the button on the connector according to the present embodiment is operated. Note that in FIGS. 10A and 10B, FIG. 10A is a front view and FIG. 10B is a cross sectional view along line A-A in FIG. 10A.

In the initial state of the connector 1, in other words, when no external force is applied, the upper surface of the operating plate part 32 of the button 30 is approximately flush with the upper surface 13a of the upper plate part 13 of the housing main body 11, as depicted in FIGS. 3A and 3B, 4A and 4B, 6A-6D, and 7A and 7B.

When the operator applies downward force to the upper surface of the operating plate part 32 using their fingers or the like, the button main body 31 swings around the rotary shaft part 31b that protrudes downward along the front end edge of the lower surface of the rotary shaft part 31b and is stowed in the recessed part 64d of each terminal 61, and as depicted in FIGS. 9 and 10A and 10B, the rear end of the operating plate part 32 is displaced downward and the front end of the operating arm part 34 is displaced upward. Therefore, as depicted in FIG. 10B, the pushing-up part 34a1 at the front end of the upper surface 34a of the operating arm part 34 abuts against the lower surface of the pushed-up part 53e of the metal fitting 51, pushing up and displacing upward the pushed-up part 53e.

At this time, with the metal fitting 51, the support part 52 is stowed and retained within the metal fitting retaining groove 14a formed in the side wall part 14 of the housing main body 11, being substantially secured thereby, and the connecting part 54, which is a long, thin, strip-shaped plate member connected to the support part 52 by the support part connecting part 54a, elastically deforms, and the pushed-up part 53e of the engaging part 53 elastically displaces upward. Specifically, the curved part consisting of the first straight part 54b, the U-shaped part 54c, and the second straight part 54d functions as a strip-shaped leaf spring extending along a path that is curved roughly like a hairpin, and therefore the connecting part 54 as a whole can be said to be a cantilever-shaped leaf spring or cantilever beam in which the support part connecting part 54a is secured and the pushed-up part 53e is a displaceable free end. In this manner, the connecting part 54 includes a portion of a path that is curved roughly in a hairpin shape, and therefore is a leaf spring with a long spring length from the support part connecting part 54a to the pushed-up part 53e of the engaging part 53, so even if the displacement of the pushed-up part 53e, which is the free end, becomes large, the connecting part can flexibly deform elastically without being plastically deformed or broken. Therefore, as depicted in FIG. 9, the entire connecting part 54 appears to be lifted up from the metal fitting stowing recessed part 14b of the side wall part 14.

In addition, considering the shape thereof, the U-shaped part 54c will not only bend but also twist. However, since the U-shaped part 54c is made of a plate member that is wider than the first straight part 54b and the second straight part 54d, the U-shaped part is durable and will not undergo plastic deformation or break.

In this manner, when the pushed-up part 53e is pushed up and displaced upward, the entire engaging part 53 is also displaced upward, so that the engagement between the engaging part 53 and the recessed part 115 of the flat cable 101 is released, enabling release of the connection between the connector 1 and the flat cable 101. Since the force exerted by the operator's fingers, and the like is considered to be sufficiently stronger than the spring force exerted by the elastic deformation of the connecting part 54, the operator can easily displace the engaging part 53 upward even if the distance from the rotary shaft part 31b to the pushing-up part 34a1 of the operating arm part 34 is longer than the distance from the rotary shaft part 31b to the upper surface of the operating plate part 32.

Note that the position at which the pushing-up part 34a1 of the operating arm part 34 abuts against the lower surface of the pushed-up part 53e is preferably close to the base end portion of the pushed-up part 53e, in other words, close to the tab part 53c. As a result, the connecting part 54, which is a cantilever-shaped member having the support-part connecting part 54a secured thereto, and the engaging part 53 are displaced upward at a position close to the position where the tab part 53c, which is positioned closer to the base end than the tip end, is connected. Therefore, the upward displacement amount of the tab part 53c can be ensured without increasing the upward displacement amount of the pushing-up part 34a1.

Next, operation of connecting the flat cable 101 to the connector 1 having the above-described configuration will be described.

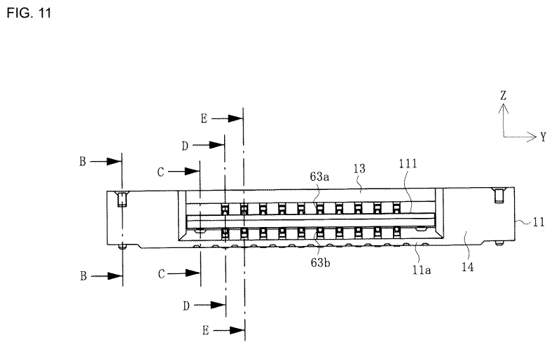

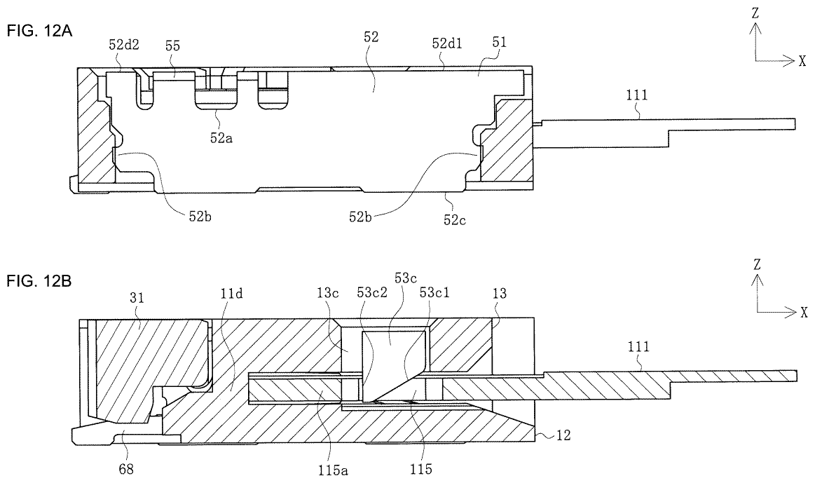

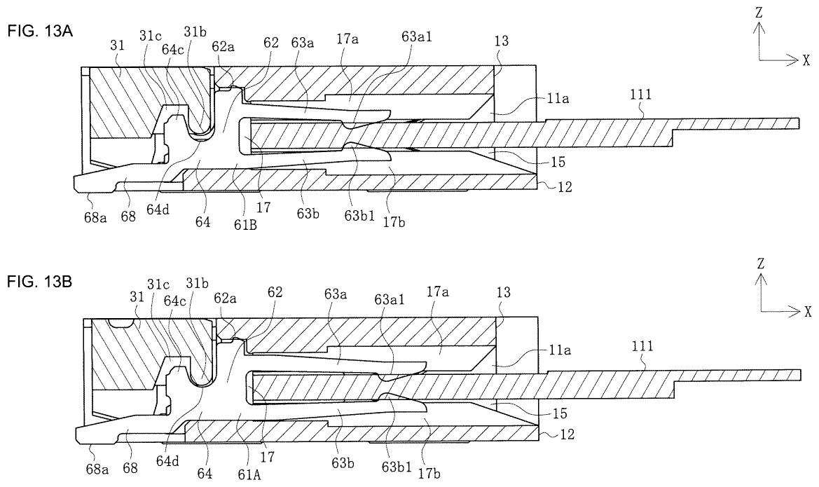

FIG. 11 is a front view depicting a state in which a flat cable is connected to the connector according to the present embodiment. FIGS. 12A and 12B are a first set of side cross sectional views depicting a state in which a flat cable is connected to a connector according to the present embodiment. FIGS. 13A and 13B are a second set of side cross sectional views depicting the state in which the flat cable is connected to the connector according to the present embodiment. Note that in FIGS. 12A and 12B, FIG. 12A is a cross sectional view along line B-B in FIG. 11, and FIG. 12B is a cross sectional view along line C-C in FIG. 11. In FIGS. 13A and 13B, FIG. 13A is a cross sectional cross sectional view along line D-D in FIG. 11, and FIG. 13B is a cross sectional view along line E-E in FIG. 11.

Here, the connector 1 is assumed to be mounted on the surface of a board (not depicted). Specifically, the lower surface of the housing main body 11 (the lower surface 12b of the lower plate part 12 of the housing main body 11) faces the surface of the board, and the lower end surfaces 68a of the tail parts 68 of each terminal 61 exposed on the lower surface 12b of the lower plate part 12 and the lower end surfaces 52c of the support parts 52 of the left and right metal fittings 51 are connected by means such as soldering to connection pads (not depicted) formed on the surface of the board. Note that the connection pad to which the lower end surface 68a of the tail part 68 of the terminal 61 is connected is connected to a conductive wire of the board.

First, the operator manipulates the flat cable 101 with their fingers or the like to cause the tip end of the flat cable 101 to face the insertion opening 11a formed in the front surface 11f of the housing main body 11 of the connector 1. In this case, the orientation of the flat cable 101 is controlled so that the exposed surface of the conductive wire 161 faces upward and the tip end is parallel to the insertion opening 11a. Note that since this terminal 61 has an upper contact part 63a1 and a lower contact part 63b1, the terminal can be connected even if the exposed surface of the conductive wire 161 is facing downward, so the orientation of the flat cable 101 can be selected as appropriate.

Furthermore, the operator moves the flat cable 101 relative to the connector 1 in the insertion direction (X-axis negative direction) and inserts the tip end of the flat cable 101 into the cable stowing space 15 of the housing main body 11 through the insertion opening 11a.

Therefore, the tab part 53c extending downward in the engaging part 53 connected to the connecting part 54 of the metal fitting 51 is pushed up by the flat cable 101, and the connecting part 54 is elastically deformed. In this case, the tab part 53c has a shape resembling a right-angled triangle that extends in a straight line and is inclined so that the front edge 53c1 thereof rises moving forward, so that the tip end of the flat cable 101 is smoothly inserted between the lower end of the tab part 53c and the upper surface 12a of the lower plate part 12. Note that since the force exerted by the operator's fingers, and the like is considered to be sufficiently stronger than the spring force exerted by the elastic deformation of the connecting part 54, the operator can easily insert the tip end of the flat cable 101.

In addition, with terminal 61A, the space between the upper contact part 63a1 formed at the tip end of the upper arm part 63a and the lower contact part 63b1 formed at the tip end of the lower arm part 63b is widened, and the upper arm part 63a and the lower arm part 63b, which function as cantilever-shaped spring members, are elastically deformed. Subsequently, when the tip end of the flat cable 101 moves further in the insertion direction, the space between the upper contact part 63a1 formed at the tip end of the upper arm part 63a and the lower contact part 63b1 formed at the tip end of the lower arm part 63b in the terminal 61B is pushed apart, and the upper arm part 63a and the lower arm part 63b, which function as cantilever-shaped spring members, are elastically deformed. In this case, the upper contact part 63a1 and the lower contact part 63b1 have a triangular shape that extends in a straight line with the front edges thereof inclined downward and upward as they move forward, so that the tip end of the flat cable 101 is smoothly inserted between the lower end of the upper contact part 63a1 and the upper end of the lower contact part 63b1.

Note that since the force exerted by the operator's fingers, and the like is considered to be sufficiently stronger than the spring force exerted by the elastic deformation of the upper arm part 63a and the lower arm part 63b, the operator can easily insert the tip end of the flat cable 101. In addition, the upper contact parts 63a1 and lower contact parts 63b1 of each terminal 61 are arranged in a staggered pattern in plan view, and the upper contact parts 63a1 and lower contact parts 63b1 of terminal 61B are positioned further rearward (X-axis negative direction) than the upper contact parts 63a1 and lower contact parts 63b1 of terminal 61A. Therefore, the tip end of the flat cable 101 first widens the space between the upper contact part 63a1 and lower contact part 63b1 of terminal 61A, and then widens the space between the upper contact part 63a1 and lower contact part 63b1 of terminal 61B. As a result, the timing at which the upper contact part 63a1 and the lower contact part 63b1 elastically deform and exert spring force is offset, allowing the operator to easily insert the tip end of the flat cable 101.

Furthermore, as depicted in FIG. 12B, when the tip end of the flat cable 101 reaches the rear wall part 11d that demarcates the rear end of the cable stowing space 15, the flat cable 101 is positioned in the insertion/removal direction, and the insertion of the flat cable 101 is completed; thereby connection to the connector 1. In this case, the tab part 53c of the engaging part 53 connected to the connecting part 54 of the metal fitting 51 enters and engages into the recessed part 115 formed on both side edges of the connection portion 101b of the flat cable 101, so there is no risk of the flat cable 101 disconnecting from the connector 1. Since the rear edge 53c2 of the tab part 53c extends in the vertical direction (Z-axis direction), even if an external force is applied to the flat cable 101 in the removal direction (X-axis positive direction), the engagement with the ear part 115a, which is in the front portion of the recessed part 115 and protrudes relatively more outward in the width direction than the recessed part 115, is not released, and the flat cable 101 can be securely retained.

In this manner, when the flat cable 101 is connected to the connector 1, each conductive wire 161 arranged on the upper surface of the board part 111 of the flat cable 101 contacts the upper contact part 63a1 of the corresponding terminal 61, thereby establishing electrical continuity with the corresponding terminal 61, and further establishing electrical continuity with the conductive traces on the board via the connection pad to which the lower end surface 68a of the tail part 68 of the terminal 61 is connected. The upper contact part 63a1 of each terminal 61 is pressed against the surface of the corresponding conductive wire 161 by the spring force exerted by the upper arm part 63a elastically deforming, and the upward spring force exerted by the lower arm part 63b elastically deforming is applied to the lower surface of the board part 111 via the lower contact part 63b1, pressing the surface of the conductive wire 161 against the upper contact part 63a1, so that the contact state between each conductive wire 161 and the upper contact part 63a1 of the corresponding terminal 61 is stably maintained.

Note that as depicted in FIGS. 13A and 13B, the recessed part 64d in the base part 62 of the terminal 61B is formed to be deeper than the recessed part 64d in the base part 62 of the terminal 61A. That is, the bottom of the recessed part 64d in the terminal 61B is positioned lower than the bottom of the recessed part 64d in the terminal 61A. Therefore, the distance between the lower end of the rotary shaft part 31b of the button 30 and the bottom of the recessed part 64d is longer for the base part 62 of the terminal 61B than for the base part 62 of the terminal 61A. Note that there are no differences between the terminal 61A and the terminal 61B with respect to the shape and dimensions of the recessed rear wall part 64c of the base part 62. The recessed rear wall part 64c, which is a protruding part on the base part 62, is inserted into and stowed in the lower surface recessed part 31c, which is a recessed part formed on the lower surface of the button main body 31. Thereby, the button 30 is positioned.

In this manner, when connecting the flat cable 101 to the connector 1, the operator only needs to move the flat cable 101 relative to the connector 1 in the insertion direction (X-axis negative direction), and no other operations are required. That is, in the present embodiment, the flat cable 101 can be connected to the connector 1 using one motion.

Next, the operation of removing the flat cable 101 from the connector 1 having the above-described configuration will be described.

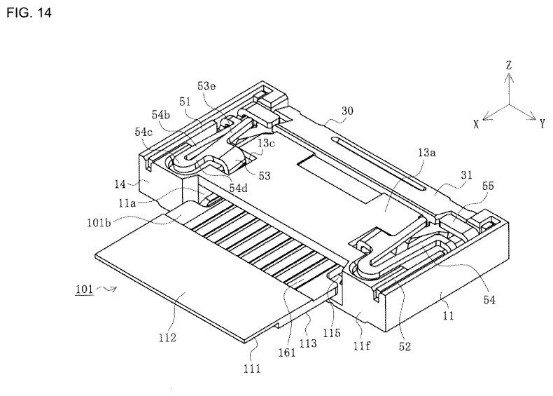

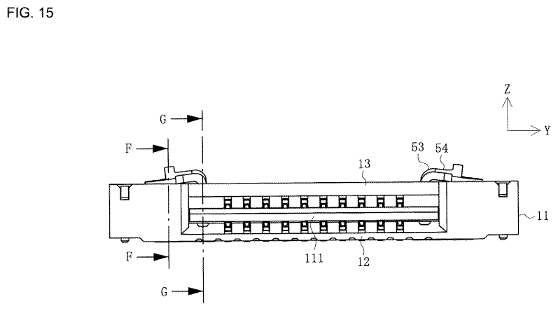

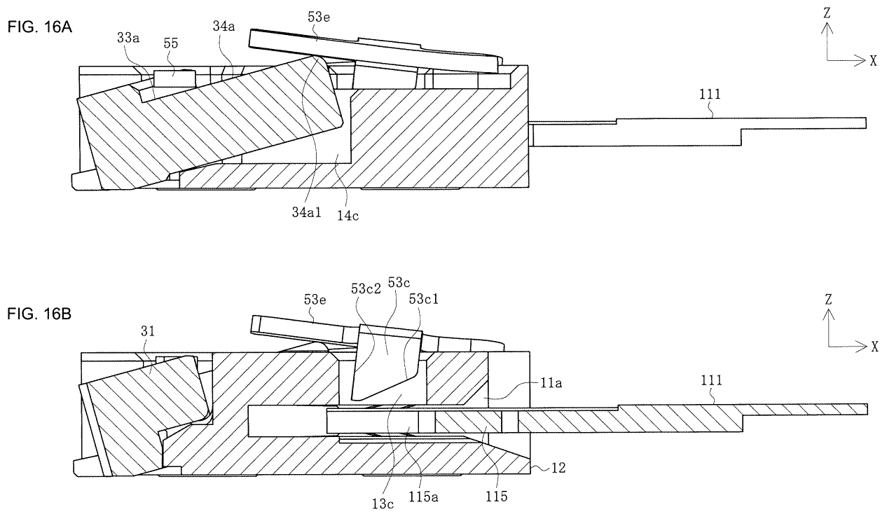

FIG. 14 is a perspective view depicting a state in which the button is operated when the flat cable is removed from the connector according to the present embodiment. FIG. 15 is a front view depicting a state in which the button is operated when the flat cable is removed from the connector according to the present embodiment. FIGS. 16A and 16B are a side cross sectional view depicting a state in which the button is operated when the flat cable is removed from the connector according to the present embodiment. Note that in FIGS. 16A and 16 B, FIG. 16A is a cross-sectional view along the line F-F in FIG. 15, and FIG. 16B is a cross-sectional view along line G-G in FIG. 15.

The flat cable 101 connected to the connector 1 is engaged and locked by the tab parts 53c of the engaging parts 53 of the pair of metal fittings 51, so that the connection will not be released even if the flat cable 101 is pulled in the removal direction (X-axis positive direction). That is, the flat cable will not come off from the connector 1. The rear edge 53c2 of the tab part 53c extends in the vertical direction (Z-axis direction), in other words, in a direction approximately perpendicular to the insertion and removal direction of the flat cable 101, so even if a force is applied to the flat cable 101 in the removal direction, the ear part 115a will not come off the tab part 53c. That is, engagement of the tab part 53c with the ear part 115a is maintained.

When removal of the flat cable 101 from the connector 1 is necessary, the operator applies downward force to one location on the upper surface of the operating plate part 32 using their fingers, or the like, and the button main body 31 swings around the rotary shaft part 31b that protrudes downward along the front end edge of the lower surface thereof and is stowed in the recessed part 64d of each terminal 61, and as depicted in FIGS. 16A and 16B, the rear end of the operating plate part 32 is displaced downward and the front end of the operating arm part 34 is displaced upward. Therefore, as depicted in FIG. 16A, the pushing-up part 34a1 at the front end of the upper surface 34a of the operating arm part 34 abuts against the lower surface of the pushed-up part 53e of the metal fitting 51, pushing up and displacing the pushed-up part 53e upward.

In this manner, when the pushed-up part 53e is pushed up and displaced upward, as depicted in FIG. 16B, the tab part 53c connected to the base end portion of the pushed-up part 53e is also displaced upward, so that the engagement between the tab part 53c and the recessed part 115 of the flat cable 101 is released, enabling release of the connection between the connector 1 and the flat cable 101. Since the force exerted by the operator's fingers, and the like is considered to be sufficiently stronger than the spring force exerted by the elastic deformation of the connecting part 54, the operator can easily displace the tab part 53c upward even if the distance from the rotary shaft part 31b to the pushing-up part 34a1 of the operating arm part 34 is longer than the distance from the rotary shaft part 31b to the upper surface of the operating plate part 32.

In addition, when the operator displaces the operating plate part 32 downward with fingers or the like, the engagement between the retaining engagement protruding part 14d and the retained engagement protruding part 33b is released, which produces a clicking sensation. Therefore, the operator can perceive that the operating plate part 32 has been displaced downward.

In this state, when the operator pulls the flat cable 101 in the direction of removal, as depicted in FIG. 14, and the like, the connection portion 101b near the tip end of the flat cable 101, whose connection with the connector 1 has been released, is displaced in the direction of removal from the cable stowing space 15. Furthermore, when the operator further pulls the flat cable 101 in the removal direction, the flat cable 101 is released from the cable stowing space 15 and is completely removed from the connector 1.

In this manner, when the flat cable 101 connected to the connector 1 is to be pulled out and removed from the connector 1, the operator can pull out and remove the flat cable 101 by simply performing the simple operation of pressing on one location on the button 30 with a finger or the like. In addition, the click sensation enables the user to easily recognize that the button 30 has been operated correctly.

Note that in the present embodiment, only the terminal 61 in which the rear part 64 connected to the rear end of the base part 62 has a recessed rear wall part 64c formed therein and configured to support the button 30 has been described, but a terminal 61 in which the rear part 64 does not have a recessed rear wall part 64c formed therein can also be used.

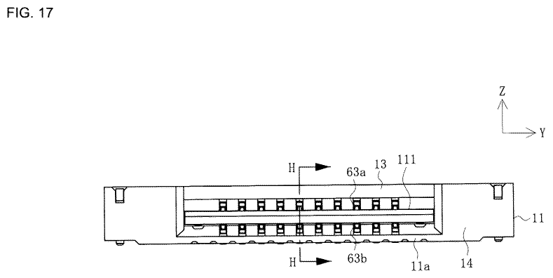

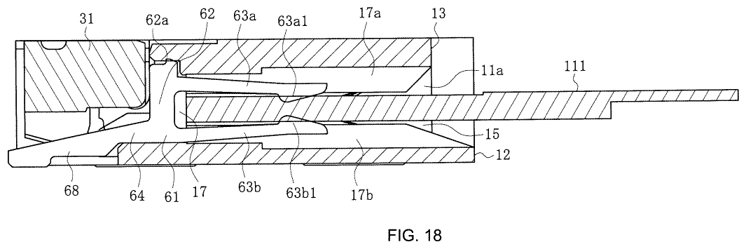

FIG. 17 is another front view depicting the state in which the flat cable is connected to the connector according to the present embodiment. FIG. 18 is a side cross sectional view depicting a state in which the flat cable is connected to the connector according to the present embodiment, and is a cross sectional view along the line H-H in FIG. 17.

Among the plurality of terminals 61 attached to the housing main body 11, some terminals may, as depicted in FIG. 18, be configured without the recessed rear wall part 64c formed in the rear part 64. If all of the terminals 61 have the recessed rear wall part 64c formed in the rear part 64, inspecting the positions of the terminals 61 becomes complicated. Therefore, by deliberately using some terminals 61 that do not have a recessed rear wall part 64c, as depicted in FIG. 18, the number of terminals 61 that are configured to support the button 30 can be minimized; simplifying inspection of the positions of the terminals 61.

In this manner, with the present embodiment, the connector 1 includes a housing 10 having an insertion opening 11a into which the flat cable 101 is inserted and a cable stowing space 15 in which the inserted flat cable 101 is stowed, a terminal 61 attached to the housing 10, a button 30 attached to the housing 10, and a metal fitting 51 attached to the housing 10. Furthermore, the metal fitting 51 includes a support part 52 that is supported by the housing 10 and an engaging part 53 that engages with the recessed part 115 of the flat cable 101, and the support part 52 and the engaging part 53 are connected by a connecting part 54 that includes a first straight part 54b, a second straight part 54d, and a U-shaped part 54c that can be understood as a roughly U-shaped curved part formed from the button 30 side toward the insertion opening 11a, and extends in the same direction as the plane of the board on which the connector 1 is mounted.

Therefore, a connector 1 that is simple in configuration, easy to manufacture, has a small and low profile, is easy to connect and disconnect, and that is highly reliable can be obtained.

In addition, the U-shaped part 54c of the curved part is formed to be wider than the first straight part 54b and the second straight part 54d, which are the other portions of the curved part. Furthermore, the engaging part 53 includes a tab part 53c extending downward, at least a portion of the tab part 53c is positioned in the engaging tab stowing opening 13c of the housing 10, and the lower end of the tab part 53c protrudes into the cable stowing space 15. Furthermore, the button 30 is of a type that is arranged on the opposite side of the housing 10 from the insertion opening 11a. Furthermore, the support part 52 includes a lower end surface 52c, and the engaging part 53 includes a pushed-up part 53e that is connected to the connecting part 54 on a first side and can come into contact with the button 30 on a second side. Furthermore, the metal fittings 51 are arranged on both sides of the housing 10 in the width direction, and when the button 30 swings, the pushed-up part 53e is pushed up, and the engagement between the engaging part 53 and the recessed part 115 of the flat cable 101 is released. Furthermore, the terminal 61 is pressed into the housing 10 from the button 30 side toward the insertion opening 11a and secured therein, and the terminal 61 includes a recessed rear wall part 64c that can be inserted into the lower surface recessed part 31c formed in the button 30.

Note that in the example depicted in the figure, in order to adjust (reduce) the insertion force generated when inserting flat cable 101, the tip end of terminal 61A is positioned forward (X-axis positive direction) of the tip end of terminal 61B, but depending on the usage situation, the tip end of terminal 61A and tip end of terminal 61B may be in the same position. In addition, although the upper contact part 63a1 and the lower contact part 63b1 of each terminal 61 are arranged in a staggered manner in plan view, the upper contact part 63a1 and the lower contact part 63b1 may be in the same position.

Note that the disclosure herein describes features relating to suitable exemplary embodiments. Various other embodiments, modifications, and variations within the scope and spirit of the patent claims appended hereto will naturally be conceived of by a person of ordinary skill in the art upon review of the specification herein.

1. A connector comprising:
a housing including an insertion opening into which a flat cable is inserted and a stowing space for stowing the inserted flat cable;
a terminal attached to the housing;
a button attached to the housing; and
a metal fitting attached to the housing, wherein
the metal fitting includes a support part supported by the housing and an engaging part that engages with an engaged part of the flat cable, and
the support part and the engaging part are connected by a connecting part, the connecting part including a roughly U-shaped curved part formed from the button side toward the insertion opening, and extending in the same direction as the plane of the board on which the connector is mounted.

2. The connector according to claim 1, wherein the U-shaped part of the curved part is formed wider than the other portion of the curved part.

3. The connector according to claim 1, wherein the engaging part includes a tab part extending downward, at least a part of the tab part being positioned within the through hole of the housing, and a lower end of the tab part protruding into the stowing space.

4. The connector according to claim 1, wherein the button is arranged on the opposite side of the housing from the insertion opening.

5. The connector according to claim 1, wherein the support part includes a board connection part, and the engaging part includes a tab, a first part of which is connected to the connecting part and a second part of which is capable of contacting the button.

6. The connector according to claim 5, wherein metal fittings are arranged on both sides of the housing in the width direction, and when the button swings, the tab is pushed up, releasing the engagement between the engaging part and the engaged part of the flat cable.
